(19) United States
(12) Patent Application Publication
(10) Pub. No.: US 2025/0044006 A1
(43) Pub. Date: Feb. 6, 2025

(54) EFFICIENCY DETERMINATION OF COOLING SYSTEMS

(71) Applicant: Grundfos Holding A/S, Bjerringbro (DK)

(72) Inventors: Christian RASMUSSEN, Bjerringbro (DK); Mike Dahl GIVERSEN, Bjerringbro (DK); Rune LANGERGAARD, Bjerringbro (DK)

(21) Appl. No.: 18/696,449

(22) PCT Filed: Oct. 7, 2022
(86) PCT No.: PCT/EP2022/077917

§ 371 Date: Mar. 28, 2024

(30) Foreign Application Priority Data
Oct. 7, 2021 (DK) PA 2021 70498

(51) Int. Cl. F25B 49/02

(52) U.S. Cl. CPC F25B 49/02; F25B 2700/151

(57) ABSTRACT

A method for determining an efficiency of a cooling system including a plurality of electrically powered cooling devices, the cooling system is configured to ramp the total cooling capacity up and down by turning the one or more cooling devices on and off either fully or partly. The method involves providing corresponding values of estimated electrical power consumption and total rated cooling capacity and monitoring and recording the total electrical power consumed by the system.

### CROSS REFERENCE TO RELATED APPLICATIONS

This application is a United States National Phase Application of International Application PCT/EP2022/077917, filed Oct. 7, 2022, and claims the benefit of priority under 35 U.S.C. § 119 of Danish Application PA 2021 70498, filed Oct. 7, 2021, the entire contents of which are incorporated herein by reference.

### TECHNICAL FIELD

The invention relates to a method for determining an efficiency of a cooling system comprising a plurality of electrically powered cooling devices, said cooling system is configured to ramp the total cooling capacity up and down by turning the one or more cooling devices on and off either fully or partly. The method involves providing corresponding values of estimated electrical power consumption and total rated cooling capacity and monitoring and recording the total electrical power consumed by the system.

### BACKGROUND

Cooling systems are widely used such as in a residential air conditioning and cooling in industries. Such cooling systems often comprises a plurality of cooling devices each having a compressor, a heat exchanger and a condenser, and cooling devices are typically electrically powered. The energy consumed by cooling devices often accounts for a substantial part, such as 40-50%, of the total energy consumption of a building.

An efficiency of a cooling device is typically calculated by

$${η}_{d} = \frac{{kW}_{d}}{{RT}_{d}}$$

Where kW_{d} is kilowatt consumed by the cooling device and RT_{d} is the refrigerant ton provided by the device. Subscript “d” refers to cooling device.

Similarly, an efficiency of a cooling system may be calculated by:

$${η}_{s} = \frac{{kW}_{s}}{{RT}_{s}}$$

Where kWₛ is to total effect in kilowatt consumed by the cooling system and RTs is the refrigerant ton provided by the system. Subscript “s” refers to the cooling system.

The efficiency may typically be provided upon e.g., purchase of a cooling device and due to the use of the cooling device and/or the environment in which it is placed the efficiency often changes. Measures are available to optimize the efficiency of a cooling device over time but requires that the efficiency is determined to reveal changes in efficiency.

Today's determination of efficiency of a cooling device is not a straightforward process as it requires that cooling devices are retrofitted with several sensors for determining values of parameters which are used to determine the efficiency. This is often made even more complicated when a plurality of cooling devices are installed in a cooling system.

Thus, as the process of determining the efficiency is complicated and often requires retrofitting of e.g., sensors, a reluctance to optimize the cooling devices exists. Hence an improved process of determining the efficiency of a cooling system would be advantageous, and in particular a more efficient process of determining the efficiency of a cooling system would be advantageous.

### SUMMARY

It may be seen as an object of the invention to provide a process of providing an efficiency of a cooling system that solves the above-mentioned problems of the prior art.

It is a further object of the invention to provide an alternative to the prior art.

Thus, the above-described object and several other objects are intended to be obtained in a first aspect of the invention by providing a method for determining an efficiency of a cooling system comprising a plurality of electrically powered cooling devices, said cooling system is configured to ramp the total cooling capacity up and down by turning the one or more cooling devices on and off either fully or partly, the method comprising:
providing for a plurality of different cooling states of the cooling system, corresponding values of estimated electrical power consumption and total rated cooling capacity;
monitoring and recording the total electrical power consumed by the system,
at a given time:
   determining an estimated total rated cooling capacity at said given time on the basis of the recorded total electrical power consumed at said given time, and the corresponding values of estimated electrical power consumption and total rated cooling capacity, and
   determining the efficiency of the cooling system on the basis of the estimated total rated cooling capacity and the recorded total electrical power consumed.

The invention solves the problem of determining the efficiency in a system comprising a plurality of cooling devices in a clever manner, where only the total electrical power consumption of the cooling devices is monitored, typically over time and the estimated total rated cooling capacity are used for determining the efficiency. The estimated total rated cooling capacity may be derived from a factory specification, a previous determination or estimation of the cooling capacity.

The inventors have realized in a cooling system comprising a plurality of cooling devices, the cooling capacity of the cooling system is ramped up or down by turning cooling devices on or off. Thereby, the timewise evolution of the power consumption of the system shows an increase or decrease when one or more cooling devices are turned on or off. The inventors have realized that an estimation of the systems efficiency, rs, at a given time may be derived inter alia on the basis of the power consumption as detailed herein.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic flow chart illustrating steps carried out according to an embodiment of the invention; and

FIG. 2 is a graph illustrating results obtained by an embodiment of the invention; the graph illustrates, as a function of time, the estimated total rated cooling capacity and total electrical power consumed. The time is given as point in time at a day (24 hours).

### DESCRIPTION OF PREFERRED EMBODIMENTS

As disclosed herein, the invention relates to a method for determining an efficiency of a cooling system comprising a plurality of electrically powered cooling devices. Such cooling devices typically comprises an electrically powered compressor for compression of a refrigerant, an evaporator for receiving heat from a location to be cooled and a condenser delivering heat typically to the surrounding. It is noted that the cooling devices may also be used as heat pumps by reversing the heat transfer.

The cooling system is configured to ramp the total cooling capacity up and down by turning the one or more cooling devices on and off either fully or partly. “Turning on” typically refers to powering the electrically powered compressor which means that an electrical current is directed into an electrical motor driving the compressor. As presented herein the turning on may result in full load referring to turn the cooling device on fully, or a partial load referring to turn the cooling device on partly. In case other equipment of the cooling system is to be turned on together with the compressor such other equipment is also turned on.

From a general perspective, a method according to the invention may comprise the following steps.

Initially knowledge about the cooling system is provided which comprises providing for a plurality of different cooling states of the cooling system, corresponding values of estimated electrical power consumption EPₘ and total rated cooling capacity RT_{ci}. That is to say that depending on the operation state of the cooling device, an estimated electrical power consumption for producing a total rated cooling capacity RT_{ci} is known. Such information is typically available from the manufacturer of a cooling device, but may be estimated either analytically or by experiments.

During operation of the cooling system the total electrical power consumed Pₘ by the cooling system is monitored. Typically, the electrical power consumed is the amount of power used in the cooling process and power consumed by other equipment linked to the cooling system not accounting for cooling may or may not be included in the total electrical power consumed.

At a given time during operation of the cooling system an estimated total rated cooling capacity ERT_{ci} is determined. This determination is carried out on the basis of the recorded total electrical power consumed Pₘ at said given time, and on the basis of the corresponding values of estimated electrical power consumption EPₘ and total rated cooling capacity RT_{ci}.

With the estimated total electrical power consumed determined, the efficiency of the cooling system ρ_{S} is determined on the basis of the determined estimated total rated cooling capacity ERT_{ci} and the recorded total electrical power consumed Pₘ.

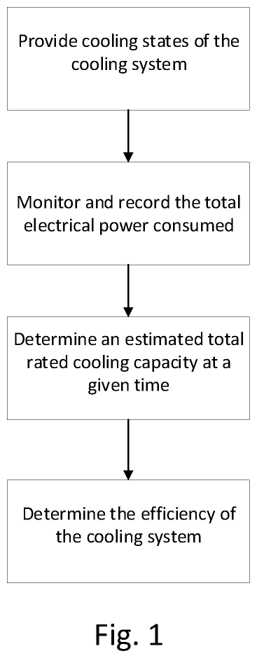

FIG. 1 schematically shows some of the steps disclosed above in accordance with an embodiment of the invention. It is to be emphasized that even though the flow chart discloses the steps as consecutive steps, the order of the steps may be altered, and some steps may be carried out in parallel.

As an example, a cooling system may comprise a number of different cooling devices. In a non-limiting example, the following system is considered:

| Cooling device | Rated cooling capacity | Quantity in cooling system |
|---|---|---|
| T1 | 100 kW | 2 |
| T2 | 150 kW | 1 |
| T3 | 200 kW | 1 |

This provides the following possibilities of cooling devices being in operation:

| | | | Estimated | |
|---|---|---|---|---|
| | | Total | electrical power | |
| Cooling | | rated | consumption | |
| states | | cooling | (EPₘ) based on | |
| (Combinations: | Cooling | capacity | efficiency | |
| Cᵢ) | device(s) | (RT_{Ci}) | (\tilde{η} = 0.75) | |
| C1 | T1 | 100 kW | 75 | kW |
| C2 | T1 + T2 | 250 kW | 187.5 | kW |
| C3 | T1 + T3 | 300 kW | 225 | kW |
| C4 | T1 + T1 + T2 | 350 kW | 262.5 | kW |
| C5 | T1 + T1 + T3 | 400 kW | 300 | kW |
| C6 | T1 + T1 + T2 + T3 | 550 kW | 412.5 | kW |
| C7 | T2 | 150 kW | 112.5 | kW |
| C8 | T2 + T3 | 350 kW | 262.5 | kW |
| C9 | T3 | 200 kW | 150 | kW |
| C10 | T1 + T2 + T3 | 450 kW | 337.5 | kW |

The estimation of electrical power consumption is based on the efficiency calculated as:

$$\tilde{η} = \frac{Electical consumption [ kW ]}{Rated cooling capacity [ kW ]} = > Estimated electrical consumption = \tilde{η} * Rated cooling capacity$$

wherein \tilde{ρ} is selected, e.g., based on an efficiency of a similar cooling system, on prior evaluations of the cooling system or based on a characteristic efficiency for the system.

### NON-LIMITING EXAMPLES ON DETERMINING WHICH COOLING STATE BEING ACTIVE AND ESTIMATION OF SYSTEM EFFICIENCY

### Example 1

Measured electrical power consumption Pₘ=185 kW
Combination of cooling devices having an estimated electrical power consumption closest to the measured is “C2”, thereby the estimated total rated cooling capacity, ERT_{ci}, is determined to be 250 kW
The efficiency is then calculated as:

$${η}_{s} = \frac{{P}_{m}}{{ERT}_{C2}} = \frac{185}{250} = 0.74$$

### Example 2

Measured electrical power consumption Pₘ=270 kW
Combination of cooling devices having an estimated electrical power consumption closest to the measured are “C4” and “C8”, thereby the estimated total rated cooling capacity, ERT_{ci}, is determined to be 350 kW.
   However, since the two combinations are similar from an efficiency perspective, the efficiency can be calculated as:

$${η}_{s} = \frac{{P}_{m}}{{ERT}_{C 4}} = \frac{{P}_{m}}{{ERT}_{C 8}} = \frac{270}{350} = 0.77$$

### Example 3

Measured power consumption Pₘ=450 kW
Combination of cooling devices having an estimated electrical power consumption closest to the measured is “C6”, thereby the estimated total rated cooling capacity, ERT_{ci}, is determined to be 550 kW
The efficiency is then calculated as:

$${η}_{s} = \frac{{P}_{m}}{{ERT}_{C 6}} = \frac{450}{550} = 0.82$$

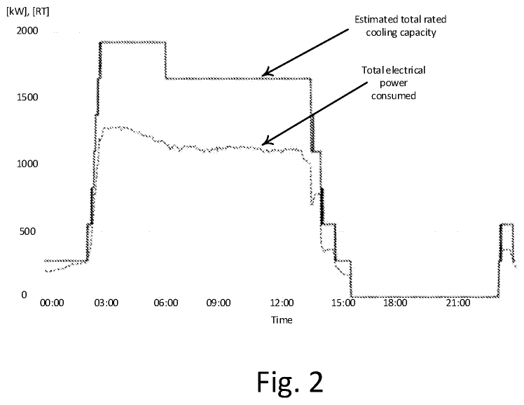

Reference is made to FIG. 2 illustrating results obtained by an embodiment of the invention; the graph illustrates, as a function of time, the estimated total rated cooling capacity and total electrical power consumed. The time is given as point in time at a day (24 hours).

In FIG. 2, the estimated total cooling capacity determined based on the method disclosed above is shown together with the total electrical power consumed. As it can be seen from the graph, estimated total rated cooling capacity determined evolves step-wise due to the selection of the cooling state having an estimated electrical power consumption EPₘ being closest to the measured electrical power consumption Pₘ.

In a system where all cooling devices are, at least from a manufacturing perspective, identical, the rated cooling capacity is equal for all cooling devices. Further, a change in power consumption may expected to be similar for each cooling device turned in or out of operation, whereby the number of cooling devices actual in operation may easily be determined.

In such a system, the above cooling states is reduced to a number n of cooling devices being in operation. Accordingly, the total rated cooling capacity, RT_{cn}, and the estimated electrical power consumption EPₘ can be evaluated as:

$$\begin{matrix}{RT}_{cn} = nRT \\ {EP}_{m} = n \tilde{η} RT\end{matrix}$$

### Example 4

The rated cooling capacity for each cooling device is 100 kW
\tilde{ρ} for each cooling device is 0.75
Measured total electrical power consumption Pₘ=515 kW
Combination of cooling devices having an estimated electrical power consumption closest to the measured is n=7 {EPₘ(N=6)=450 kW and EPₘ(N=7)=525 kW}. Thereby, the estimated total rated cooling capacity, ERT_{ci}, is determined to be 525 kW. The efficiency is then calculated as:

$${η}_{s} = \frac{{P}_{m}}{{ERT}_{Cn}} = \frac{515}{525} = 0.98$$

As presented in the above examples, the estimated electrical power consumption EPₘ for each of the cooling states may be provided on the basis of a selected efficiency \tilde{ρ} correlating the total rated cooling capacity with the estimated electrical power consumption. In the above examples, the efficiency \tilde{ρ} is selected to be 0.75, however, other values such as values between 0.5 and 1.1 have proven to show good results. The selected efficiency may be empirically determined, determined based on experiments or may be an efficiency provided by the manufacturer of the cooling devices.

Although the selected efficiency may vary depending on cooling states, the selected efficiency \tilde{ρ} is in preferred embodiments selected to be the same value for all cooling states.

In addition, the selected efficiency \tilde{ρ} may be the same for all cooling device or it may be an individual selected efficiency for a specific cooling device.

The efficiency of a cooling device may in some instances vary depending on the temperature levels the condenser and/or evaporator is/are exposed to. Such temperature levels vary typically over a calendar year and in some embodiments, the selected efficiency \tilde{ρ} is selected in accordance with the season in which cooling system is in operation.

As presented in the above examples, a difference is often found between the recorded total power consumed Pₘ and estimated electrical power consumption EPₘ. To account for such differences, determination of the total estimated total rated cooling capacity ERT_{ci} at the given time further may comprise the steps of:
identifying in the corresponding values of estimated electrical power consumption EPₘ and total rated cooling capacity RT_{ci}, a numerical closest estimated electrical power consumption EPₘ as being numerically closest to the recorded total power consumed Pₘ,
assigning the total rated cooling capacity RT_{ci} corresponding to said numerical closest estimated electrical power consumption ERT_{ci} to be the determined estimated total rated cooling capacity ERT_{ci} at said given time.

With reference to e.g., Example 1 above, the measured (recorded) electrical power consumption Pₘ is 185 kW, and a table look up shows that there are two cooling states which candidates to be in operation, namely “C2” with EPₘ=187.5 and “C9” with EPₘ=150 kW. From this, “C2” is found to be the numerical closest and the estimated total rated cooling capacity is then assigned to be 250 kW.

In many preferred embodiments, a cooling state is a number of cooling devices turned on, and cooling states are different combinations of cooling devices being turned on. A cooling state may be obtained by turning more than one cooling device on or off substantially at the same time or a cooling state may be obtained by turning a single cooling device on or off.

In some embodiments, cooling devices are clustered in the sense that although they are individual cooling devices they are turned on or off in common. For such a cluster, a cluster may be considered as an individual cooling device in relation to preferred embodiments of a method according to the invention.

As detailed in the above example involving three types of cooling devices, the cooling system for which an efficiency is determined may comprise cooling devices having different rated cooling capacities. However, the invention is not limited to cooling systems having different cooling devices as also detailed in the above Example 4 where all cooling devices are, at least from a manufacturing perspective, identical.

In embodiments where cooling devices are clustered as detailed above, such a cluster may comprise either identical cooling devices (from a manufacturing perspective) or cooling devices having different rated cooling capacities. Accordingly, the cooling system may comprise a number of identical (from a manufacturing perspective) clusters where each cluster comprises different (from a manufacturing perspective) cooling devices.

As the efficiency of the cooling system may depend on the cooling state, the efficiency of the cooling system ρ_{S} may be determined at different cooling states of the system.

The total electrical power consumed Pₘ may be evaluated as kWh or kW. When kWh is used, the monitoring and recording of the total electrical power consumed by the system is carried out as a function of time.

Independently of whether the total electrical power consumed is evaluated as kW or kWh, it may be necessary to monitor and record total electrical power consumed in a time window and determine the total electrical power consumed by the system by averaging, with respect to time, a time series of recorded total electrical power consumed within the time window. By this, minor fluctuations naturally occurring in measured power consumption may be averaged out. The length of the time series or time window may be selected based on statistic evaluations e.g., as a time period where the standard deviation of measured power over time is less than a deviation between to nearest cooling states. Although such a time period depends on a frequency of which the cooling state changes, non-limiting examples of the length of a time series are larger than 5.0 minutes and less than 60.0 minutes.

In many embodiments, the cooling devices, when turned on, operate in full load. However, the invention is not limited to such full load scenarios as one or more of the cooling devices may be being adapted to operate in partial load, e.g., by the cooling devices comprising Variable Frequency Drives, thus allowing the compressor (or other electrically driven devices) to be operated at one or more partial loads.

As presented in the examples above, the efficiency of the cooling system ρ_{S} may be determined as the ratio between the recorded total power consumed and the determined estimated total rated cooling capacity.

Although the invention has been described in connection with the specified embodiments, it should not be construed as being in any way limited to the presented examples. The scope of the invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

While specific embodiments of the invention have been shown and described in detail to illustrate the application of the principles of the invention, it will be understood that the invention may be embodied otherwise without departing from such principles.

1. A method for determining an efficiency of a cooling system comprising a plurality of electrically powered cooling devices, said cooling system is configured to ramp the total cooling capacity up and down by turning the one or more cooling devices on and off either fully or partly, the method comprising:
providing for a plurality of different cooling states of the cooling system, corresponding values of estimated electrical power consumption and total rated cooling capacity;
monitoring and recording the total electrical power consumed by the system,
at a given time:
determining an estimated total rated cooling capacity at said given time on the basis of the recorded total electrical power consumed at said given time, and the corresponding values of estimated electrical power consumption and total rated cooling capacity, and
determining the efficiency of the cooling system on the basis of the estimated total rated cooling capacity and the recorded total electrical power consumed.

2. A method according to claim 1, wherein the estimated electrical power consumption for each of the cooling states is provided on the basis of a selected efficiency correlating the total rated cooling capacity (RT_{ci}) with the estimated electrical power consumption.

3. A method according to claim 2, wherein the selected efficiency is the same value for all cooling states.

4. A method according to claim 2, wherein the selected efficiency is selected in accordance with the season in which cooling system is in operation.

5. A method according to claim 1, wherein determining the estimated total rated cooling capacity at said given time further comprising:
identifying in the corresponding values of estimated electrical power consumption and total rated cooling capacity, a numerical closest estimated electrical power consumption as being numerically closest to the recorded total power consumed,
assigning the total rated cooling capacity corresponding to said numerical closest estimated electrical power consumption to be the determined estimated total rated cooling capacity at said given time.

6. A method according to claim 1, wherein said cooling states are different combinations of cooling devices being turned on.

7. A method according to claim 1, wherein the cooling system comprising cooling devices having different rated cooling capacities.

8. A method according to claim 1, wherein the efficiency of the cooling system is determined at different cooling states of the system.

9. A method according to claim 1, wherein the monitoring and recording the total electrical power consumed by the system are carried out as a function of time.

10. A method according to claim 9, wherein the total electrical power consumed by the system is determined by averaging with respect to time a time series of recorded total electrical power consumed.

11. A method according to claim 1, wherein the cooling devices, when turned on, operate in full load.

12. A method according to claim 1, wherein one or more of the cooling devices is adapted to operate in partial load.

13. A method according to claim 1, wherein the efficiency of the cooling system is determined as the ratio between the recorded total power consumed and the determined estimated total rated cooling capacity.

14. A method according to claim 1, wherein the estimated electrical power consumption for each of the cooling states is provided on the basis of a selected efficiency correlating the total rated cooling capacity with the estimated electrical power consumption, the selected efficiency being selected between 0.5 and 1.1.

15. A method according to claim 9, wherein the total electrical power consumed by the system is determined by averaging with respect to time a time series of recorded total electrical power consumed, the time series having time length larger than 5.0 minutes and less than 60.0 minutes.
